(19) United States
(12) Patent Application Publication
(10) Pub. No.: US 2025/0369621 A1
(43) Pub. Date: Dec. 4, 2025

(54) COOKING APPLIANCE WITH DIGITAL CONTROLLER DOOR AND METHOD FOR MONITORING THERMISTOR OF COOKING APPLIANCE

(71) Applicant: LG Electronics Inc., Seoul (KR)

(72) Inventors: Dong Hun KIM, Seoul (KR); Young Jin KIM, Seoul (KR); Jeongkil KIM, Seoul (KR); Junhwan JANG, Seoul (KR); Geon KWON, Seoul (KR); Hansu LEE, Seoul (KR)

(73) Assignee: LG Electronics Inc., Seoul (KR)

(21) Appl. No.: 19/220,958

(22) Filed: May 28, 2025

(30) Foreign Application Priority Data
May 30, 2024 (KR) 10-2024-0070766
Dec. 16, 2024 (KR) 10-2024-0187288

(51) Int. Cl. F24C 7/08; F24C 7/02; F24C 15/02

(52) U.S. Cl. CPC F24C 7/086; F24C 7/02; F24C 15/02

(57) ABSTRACT

Disclosed are a cooking appliance including a digital controller door and a method for monitoring a thermistor of the cooking appliance, and the cooking appliance includes a functional unit configured to provide a cooking function, wherein the functional unit includes a function controller for controlling an operation of the functional unit; and the digital controller door configured to provide a human interface, wherein digital controller door includes an operating system (OS) controller for controlling the digital controller door, wherein the function controller determines whether a thermistor error occurs, wherein when the OS controller receives thermistor error notification from the function controller, the OS controller starts a thermistor error response process.

### CROSS-REFERENCE TO RELATED APPLICATION

This application claims the priority to and the benefit of Korean Patent Application No. 10-2024-0070766, filed on May 30, 2024, and Korean Patent Application No. 10-2024-0187288, filed on Dec. 16, 2024, in the Korean Intellectual Property Office, the disclosures of all of which are incorporated herein by reference in their entireties.

### BACKGROUND

### Field

The present disclosure relates to a cooking appliance including a digital controller door and a method for monitoring a thermistor of the cooking appliance.

### Description of Related Art

A cooking appliance is a home appliance that cooks food using microwaves belonging to electromagnetic waves and/or heater heat. The cooking appliance may be generally provided with a cavity as a space in which food is placed and cooked, and a door for opening and closing the cavity.

When the cooking appliance is installed indoors, it is necessary to consider efficient use of the cooking appliance, saving of an installation space thereof, etc.

For this reason, the cooking appliance may be disposed at a position adjacent to a heating cooking device, for example, a heating oven, a gas stove, etc. Specifically, the cooking appliance may be disposed on top of the heating cooking device.

When the cooking appliance is disposed on top of the heating cooking device, the user may conveniently cook food by reducing the movement of the user in an environment in which the cooking appliance and the heating cooking device are adjacent to each other. In addition, heat, oil vapor, etc. as generated from the heating cooking device may be discharged to the outside using the cooking appliance as a hood.

In a state in which the cooking appliance is disposed on top of the heating cooking device, heat, oil vapor, or the like generated from the heating cooking device disposed under the cooking appliance may adversely affect the operation of the cooking appliance.

For example, a display may be mounted on a front surface of a door provided in the cooking appliance and may be configured to provide various information to the user. The user may know a cooking state of the cooked food through the display.

In addition, when the display is connected to another home appliance so as to serve as a hub of the home appliances, information other than cooking food may be obtained through the display. In addition, the user may input a command necessary for cooking and various other commands to the display in a touch manner.

In a state in which the cooking appliance is disposed on top of the heating cooking device, heat, oil vapor, etc. generated from the heating cooking device may invade into parts mounted on the display and the door.

It is necessary to suppress damage to or malfunction of the display of the cooking appliance and other components mounted on the door due to such heat, oil vapor, or the like.

The heat generated from the heating cooking device may rise under a convection to heat the display mounted on the cooking appliance, thereby causing the display to be damaged by the heat or causing a malfunction of the display.

Therefore, proper cooling is required so that the display is not heated. At least one fan device may be used to cool the display. However, when a large number of fan devices are used to cool the display or the fan device is rotated at an excessively high speed, noise of the fan device may make the user uncomfortable and excessive electricity may be consumed by the fan device.

A component for controlling the display and a component for controlling the operation of the cooking appliance operate in different operating manners. The component that controls the display may act as an information processing unit in that it interacts with the user. On the other hand, the cooking appliance may repeatedly perform a specific function.

Accordingly, a scheme of defining a control of these two components or information flow manner therebetween and setting a process corresponding thereto so that the cooking appliance may be safely controlled in a normal operation and an abnormal operation situation is required. In particular, a thermistor for measuring a temperature of an environment in which the cooking appliance is installed should be provided for safety. In this regard, when an error occurs in the thermistor, it is necessary to safely control the cooking appliance.

### SUMMARY

Thus, the present disclosure has been devised to solve the above problem. A purpose of the present disclosure is to provide various software or hardware of a door coupled to the cooking appliance cooperates smoothly with a control component for controlling the cooking appliance, and particularly, when an error of the thermistor occurs, components of the cooking appliance may be safely controlled.

Further, a purpose of the present disclosure is to provide a technology for determining whether an error has occurred in the thermistor of the cooking appliance.

Furthermore, a purpose of the present disclosure is to provide a technology for controlling operation performed by the cooking appliance when the error occurs in the thermistor of the cooking appliance.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

A cooking appliance including a digital controller door according to an embodiment of the present disclosure includes a functional unit configured to provide a cooking function, wherein the functional unit includes a function controller for controlling an operation of the functional unit; and the digital controller door configured to provide a human interface, wherein digital controller door includes an operating system (OS) controller for controlling the digital controller door, wherein the function controller is configured to determine whether a thermistor error occurs, wherein when the OS controller receives thermistor error notification from the function controller, the OS controller is configured to start a thermistor error response process.

A method for monitoring a thermistor by a digital controller door of a cooking appliance according to an embodiment of the present disclosure is provided. The cooking appliance includes: a functional unit configured to provide a cooking function, wherein the functional unit includes a function controller for controlling an operation of the functional unit; and the digital controller door configured to provide a human interface, wherein digital controller door includes an operating system (OS) controller for controlling the digital controller door, wherein the method comprises: determining, by the function controller, whether a thermistor error occurs; receiving, by the OS controller, thermistor error notification from the function controller; and starting, by the OS controller, a thermistor error response process.

In accordance with the present disclosure, the various software or hardware of the door coupled to the cooking appliance cooperates smoothly with the control component for controlling the cooking appliance, and particularly, when the error of the thermistor occurs, the components of the cooking appliance may be safely controlled.

In accordance with the present disclosure, whether the error occurs in the thermistor of the cooking appliance may be determined. Thus, when the error occurs in the thermistor of the cooking appliance, the operation performed by the cooking appliance may be controlled.

The effects of the present disclosure are not limited to the above-described effects, and those skilled in the art may easily derive various effects of the present disclosure from the configuration of the present disclosure.

### BRIEF DESCRIPTION OF DRAWINGS

FIG. 1 is a conceptual diagram of a cooking appliance including a digital controller door according to an embodiment of the present disclosure.

FIG. 2 is a diagram illustrating components of a digital controller door and components of a functional unit according to an embodiment of the present disclosure.

FIG. 3 is a diagram illustrating categories of functions performed by an OS controller and a function controller according to an embodiment of the present disclosure.

FIG. 4 is a perspective view illustrating a cooking appliance according to an embodiment of the present disclosure.

FIG. 5 is a diagram illustrating a state in which the digital controller door 100 is opened in FIG. 4.

FIG. 6 is a perspective view illustrating a digital controller door of a cooking appliance according to an embodiment of the present disclosure.

FIG. 7 is a schematic view illustrating a position where a cooking appliance is disposed according to an embodiment of the present disclosure.

FIG. 8 is a diagram illustrating a process in which a cooking appliance monitors a state of a thermistor and responds to an error thereof, according to an embodiment of the present disclosure.

FIG. 9 is a diagram illustrating a process in which a cooking appliance monitors a state of a thermistor and responds to an error thereof, according to another embodiment of the present disclosure.

FIG. 10 is a diagram illustrating a process responding to a situation in which an error of a thermistor has been solved and thus the thermistor operates normally, according to an embodiment of the present disclosure.

FIG. 11 is a diagram illustrating a process responding to a situation in which an error of a thermistor has been solved and thus the thermistor operates normally, according to another embodiment of the present disclosure.

FIG. 12 is a diagram illustrating a process in which a function controller monitors an operation state of a thermistor according to an embodiment of the present disclosure.

FIG. 13 is a diagram showing an error response process and an error-removal response process of an OS controller according to an embodiment of the present disclosure.

FIG. 14 is a diagram illustrating a process in which an OS controller uses a past history in controlling operations of respective components according to an embodiment of the present disclosure.

FIG. 15 is a diagram illustrating a process in which an OS controller responds to an cumulative error state of a thermistor, according to an embodiment of the present disclosure

FIG. 16 is a diagram showing a thermistor error message displayed on a display according to an embodiment of the present disclosure.

### DETAILED DESCRIPTIONS

Hereinafter, embodiments of the present disclosure will be described in detail with reference to the drawings so that those skilled in the art to which the present disclosure pertains can easily implement the present disclosure. The present disclosure may be implemented in several different forms and is not limited to the embodiments described herein.

In order to clearly describe the present disclosure, parts irrelevant to the description are omitted, and the same reference numerals refer to the same or similar components throughout the specification. Further, some embodiments of the present disclosure will be described in detail with reference to the example drawings. In adding reference numerals to the components of each drawing, the same components may be denoted by the same reference numerals as much as possible even though the components are shown in different drawings. In addition, in describing the present disclosure, when it is determined that a detailed description of related known components or functions may obscure the gist of the present disclosure, the detailed description thereof may be omitted.

It will be understood that, although the terms “first”, “second”, “third”, and so on may be used herein to describe various elements, components, areas, layers and/or units, these elements, components, areas, layers and/or units should not be limited by these terms. These terms are used to distinguish one element, component, area, layer or unit from another element, component, area, layer or unit. Thus, a first element, component, area, layer or unit as described under could be termed a second element, component, area, layer or unit, without departing from the spirit and scope of the present disclosure. It will be understood that when a first element or layer is referred to as being “connected to”, “jointed to” or “coupled to” a second element or layer, the first element may be directly connected to or jointed to or coupled to the second element or layer, or one or more intervening elements or layers may be present therebetween. In addition, it will also be understood that when an element or layer is referred to as being “between” two elements or layers, it may be the only element or layer between the two elements or layers, or one or more intervening elements or layers may also be present therebetween.

In addition, in the implementation of the present disclosure, the component may be subdivided for convenience of description. However, this component may be implemented in one device or module, or one component may be implemented so as to be distributed into a plurality of devices or modules.

The present disclosure relates to a technique for controlling a cooking appliance using a digital controller door disposed at a front surface of the cooking appliance.

According to the present disclosure, a door of a microwave oven disposed on an oven or a gas stove includes a LCD or OLED screen. An Android of the LCD or OLED screen and a microcomputer of the microwave oven cooperate with each other. A LCD or OLED component operates according to various operating/external environments of the microwave oven or controls a specific function of the microwave oven.

The digital controller door of the present disclosure may be combined with the cooking appliance to open and close the inside of the cooking appliance. An embodiment of the cooking appliance of the present disclosure is a microwave oven. However, embodiments of the present disclosure is not limited thereto. An embodiment of the cooking appliance including the digital controller door of the present disclosure includes each of various cooking appliances which includes a door equipped with a display such as a LCD or OLED providing various user interfaces such as a touch screen, and is capable of storing and cooking food therein. And embodiments of the present disclosure is not limited on a specific display panel type.

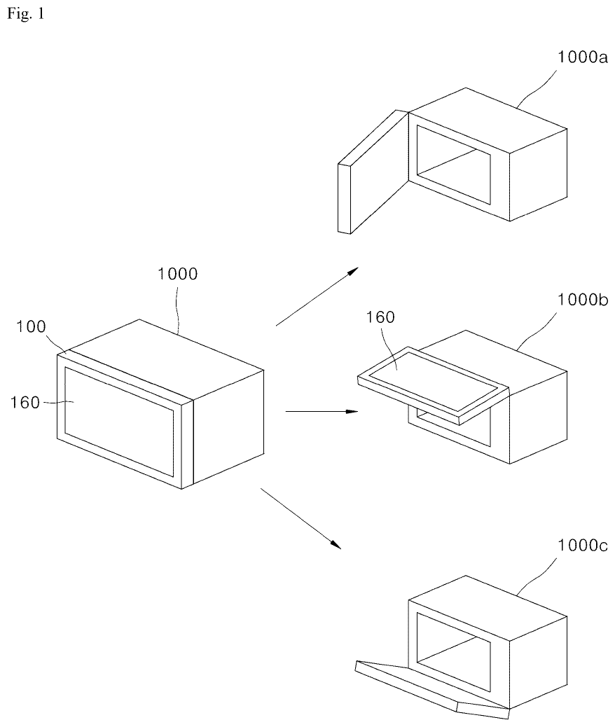

FIG. 1 is a conceptual diagram of a cooking appliance including a digital controller door according to an embodiment of the present disclosure.

The cooking appliance 1000 includes a digital controller door 100 at a front surface thereof. The digital controller door 100 includes one or two or more displays, and the display of the digital controller door 100 may display information about the inside of the cooking appliance 1000 or information related to an operation thereof to the user. The display of the digital controller door 100 may provide a touch input interface for receiving a predetermined command from the user.

A manner in which the digital controller door 100 is opened includes an embodiment 1000a, 1000b, or 1000c. 1000a shows an embodiment in which the digital controller door 100 pivots around a left side of the cooking appliance 1000a to open the right side of the cooking appliance 1000a, and open the inside of the cooking appliance 1000a. 1000b shows an embodiment in which the digital controller door 100 pivots around a top side of the cooking appliance 1000b to open the bottom side of the cooking appliance 1000b, and open the inside of the cooking appliance 1000b. 1000c shows an embodiment in which the digital controller door 100 pivots around a bottom side of the cooking appliance 1000c to open the top side of the cooking appliance 1000c, and open the inside of the cooking appliance 1000c.

A display 160 may be mounted on the front surface of the digital controller door 100 to provide various information to a user. The user may know the cooking state of the cooked food on the display 160. The display 160 may be embodied as a LCD. However, embodiments of the present disclosure is not limited thereto, and the display 160 may include various display panels. In addition, a touch panel for touch input may be coupled to the display 160.

The digital controller door 100 controls the operation of the cooking appliance 1000 and outputs various information. The cooking appliance 1000 performs cooking using microwaves or heater heat. Accordingly, a digital controlling function provided by the digital controller door 100 and a cooking function of the cooking appliance 1000 are provided in different ways and in different areas.

The digital controller door 100 of the present disclosure may serve as a kind of a hub. That is, the digital controller door 100 may serve as a hub of another home appliance and display information transmitted from another home appliance on the display 160. In this process, the user may obtain other information other than the cooking food on the display 160. In addition, the user may input a command necessary for cooking and various other commands to the display 160 in a touch manner.

To this end, in accordance with the present disclosure, a method and a configuration in which the digital controller door 100 and the cooking appliance 1000 respectively include independent control components, and these control components cooperate with each other to control the function of the cooking appliance will be described.

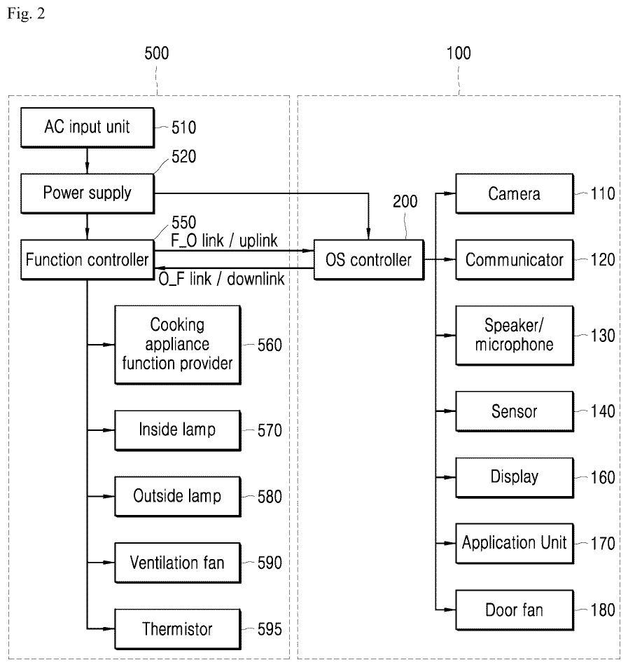

FIG. 2 is a diagram illustrating components of a digital controller door and components of a functional unit according to an embodiment of the present disclosure. Each of the components is conceptually disposed and is not limited to a specific physical location or material.

The digital controller door 100 may operate as an Internet-of-things hub. The digital controller door 100 may include an OS controller 200. In addition, the digital controller door 100 may include a camera 110. In addition, the digital controller door 100 may include a communicator 120. In addition, the digital controller door 100 may include a speaker/microphone 130. In addition, the digital controller door 100 may include a sensor 140. In addition, the digital controller door 100 may include the display 160. In addition, the digital controller door 100 may include an application unit 170. In addition, the digital controller door 100 may include a door fan 180. The door fan may be embodied as a direct current (DC) fan and cools the heat of the digital controller door 100. In particular, the door fan 180 cools heat generated from the display 160.

Hereinafter, the OS controller 200, the camera 110, the communicator 120, the speaker/microphone 130, the sensor 140, the display 160, the application unit 170, and the door fan 180 are referred to as elements or components of the digital controller door 100

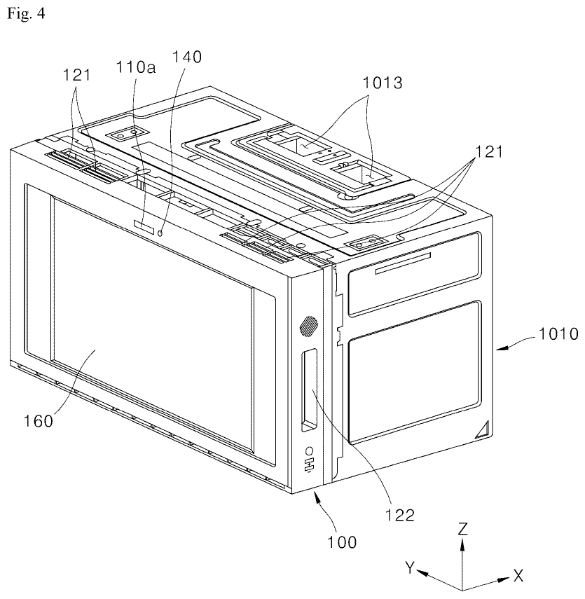

The functional unit 500 includes an AC input unit 510, a power supply 520, a function controller 550, a cooking appliance function provider 560, an inside lamp 570, an outside lamp 580, a ventilation fan (vent fan) 590, etc. The functional unit 500 and the digital controller door 100 are logically configured for the description of the present disclosure. The functional unit 500 may be implemented as a body 1010 illustrated in FIG. 4. Accordingly, the functional unit 500 may further include various physical components necessary for implementation as the body 1010 in addition to the components illustrated in FIG. 2.

The OS controller 200 controls various components of the digital controller door 100.

In addition, the OS controller 200 transmits a predetermined signal to the function controller 550, and allows the function controller 550 to control the performance of a specific function of the cooking appliance 1000. In addition, the function controller 550 may transmit a signal to the OS controller 200. This allows the function controller 550 to inform the OS controller 200 of a result related to the performance of a specific function of the cooking appliance 1000. The OS controller 200 may operate based on a specific OS (e.g., Android).

According to an embodiment, the function controller 550 and the OS controller 200 may operate independently and may communicate a predetermined signal with each other when there is information to be notified to each other. A type of signal may be based on various communication protocols such as wired communication or wireless communication. According to an embodiment, when the OS controller 200 receives information from the user and is instructed to perform a specific function of the cooking appliance, the OS controller 200 may transmit a specific signal to the function controller 550. In this case, the function controller 550 operates the functional unit 500, for example, the body 1010.

The function controller 550 may be embodied as a microcomputer for generating a signal for operating the functional unit 500, for example, the body 1010.

The camera 110 may be disposed on the digital controller door to photograph the outside of the cooking appliance 1000, photograph the surroundings, or photograph a cooking space inside the cooking appliance 1000.

In addition, the camera 110 may be disposed inside the digital controller door 100. The camera 110 may photograph the inside of the cooking appliance 1000 to allow the user to check the cooking state of the food stored therein.

Accordingly, the camera 110 may be disposed to face outwardly of the digital controller door 100 (toward the user) and to face inwardly of the digital controller door 100 (toward the inside of the cooking appliance). In this case, the display 160 may output an image obtained by photographing the outside out of the cooking appliance or the inside of the cooking appliance based on the cooking state or a state of the function performed by the digital controller door 100.

The communicator 120 may perform various types of wired or wireless communication functions. The communicator may communicate with another device (e.g., an external server, a hub disposed in a home, or another home appliance) using a communication protocol such as Wi-Fi, Bluetooth, or the like.

The speaker/microphone 130 may generate a voice, an alarm sound, etc. necessary for the operation of the cooking appliance 1000, and may receive a predetermined external voice command or an external sound. The speaker/microphone 130 may be integral with each other or may be disposed at different positions.

The sensor 140 senses an environment outside or inside the cooking appliance 1000. For example, the sensor 140 may include a temperature sensor, an illuminance sensor, a human sensor, a humidity sensor, etc.

The display 160 outputs visual information to be provided to a user. The information provided from the display 160 includes a cooking function or state of the cooking appliance 1000 in operation, an interface for controlling the cooking appliance 1000, and information on a surrounding environment in which the cooking appliance 1000 is disposed.

In addition, when the digital controller door 100 operates as an Internet-of-things hub, the display 160 may display various information in addition to cooking related information. In addition, the display 160 may convert a user's touch into an input signal.

The application unit 170 stores therein various application programs as executed by the digital controller door 100, and the OS controller 200 may execute the application programs stored in the application unit 170 and may display the execution results on the display 160.

The door fan 180 embodied as the direct current fan is configured to cool heat generated in various electronic devices related to a digital controller door. The door fan 180 may cool the heat generated from the display 160 or the OS controller 200.

The OS controller 200 may download various application programs through the communicator 120 and store and install the application programs in the application unit 170.

The application program according to an embodiment of the present disclosure includes an application program directly or indirectly related to the operation or function of the cooking appliance 1000, such as an application program for controlling the cooking of the cooking appliance 1000, an application program related to an image or a video to be displayed during the operation of the cooking appliance 1000, etc. In this case, the OS controller 200 may control a function of the cooking appliance 1000 by controlling the function controller 550 using the application program.

In addition, the application program according to an embodiment of the present disclosure includes an application program necessary for the digital controller door 100 to operate as the Internet of Things hub.

The AC input unit 510 constituting the functional unit 500 receives power required for the cooking appliance 1000 to operate. The supplied power is provided to the function controller 550 and the OS controller 200 through the power supply 520.

The function controller 550 controls the functions of the cooking appliance 1000. In this regard, the function controller 550 receives a signal from the OS controller 200 and controls the functions of the cooking appliance 1000. The function controller 550 may control an operation of each of the cooking appliance function provider 560, the inside lamp 570, the outside lamp 580, the ventilation fan (Vent Fan) 590, and the thermistor 595 according to the signal received from the OS controller 200. Hereinafter, the cooking appliance function provider 560, the inside lamp 570, the outside lamp 580, the ventilation fan 590, and the thermistor 595 are referred to as elements or components of the functional unit 500.

The cooking appliance function provider 560 generates microwaves or heater heat to cook food stored in the cooking appliance 1000.

The inside lamp 570 is disposed inside the cooking appliance 1000 that is opened and closed by the digital controller door 100. When the digital controller door 100 is opened or closed, the inside lamp 570 may be turned on and off. Alternatively, when the cooking appliance 1000 is cooking the food, the inside lamp 570 may be turned on so that the internal camera may capture an image thereof.

The outside lamp 580 is disposed at a lower end or an upper end of the cooking appliance 1000. When the cooking appliance 1000 is disposed on top of a separate cooktop, the outside lamp 580 may be disposed at a lower end of the cooking appliance 1000.

The ventilation fan 590 discharges heat generated from the cooktop to the outside.

The thermistor 595 is a component disposed in the functional unit 500 to sense a temperature. One or more thermistors 595 may be disposed at the cooking appliance 1000.

According to an embodiment of the present disclosure, the thermistor 595 may provide information on the sensed temperature to the function controller 550. According to another embodiment of the present disclosure, the thermistor 595 may be included in the sensor 140, and in this case, information on the sensed temperature may be provided to the OS controller 200 that controls the sensor 140.

The food stored in the cooking appliance 1000 is cooked via the operation of the cooking appliance function provider 560. Even in this process, the function controller 550 and the OS controller 200 may communicate information with each other per a preset time interval.

The OS controller 200 provides a UI/UX function. In addition, the OS controller 200 transmits a predetermined signal to the function controller 550, and the function controller 550 controls the operation of the cooking appliance 1000, for example, the body 1010 or the functional unit 500. In addition, the function controller 550 may control an operation of the cooking appliance function provider 560 and provide an information value generated therefrom during control to the OS controller 200.

Accordingly, the control flow of the OS controller 200 and the function controller 550 is configured such that the OS controller 200 transmits a predetermined signal to the function controller 550 and then receives a predetermined control result from the function controller 550.

The OS controller 200 and the function controller 550 may communicate with each other in a wired or wireless manner. The OS controller 200 and the function controller 550 may communicate with each other using various communication protocols, and embodiments of the present disclosure are not limited to a specific communication protocol.

As illustrated in FIG. 2, a communication link via which the function controller 550 transmits predetermined data to the OS controller 200 or performs control is referred to as a F_O link or an uplink. A communication link via which the OS controller 200 transmits predetermined data to the function controller 550 or performs control is referred to as an O_F link or a downlink. However, embodiments of the present disclosure are not limited to a specific name or a direction such as upward/downward, and the links may be distinguished from each other based on a direction of data transmission between the components 550 and 200.

In an embodiment of the present disclosure, the link may physically use one or more lines or may use one or more communication media. In addition, in accordance with the present disclosure, a name is separately given to each data transmission direction in order to distinguish logically the data transmission directions from each other.

According to an embodiment of the present disclosure, in the case of the wired communication, the OS controller 200 and the function controller 550 may communicate with each other using a communication protocol such as Universal asynchronous receiver/transmitter (UART) and Universal Serial Bus (USB).

According to an embodiment of the present disclosure, in the case of the wireless communication, the OS controller 200 and the function controller 550 may communicate with each other using a communication protocol such as Zigbee, Wi-Fi, and Bluetooth.

Each of the OS controller 200 and the function controller 550 may include a separate memory (internal memory), and may store, in the memory, function result information or error information generated in the process of performing a function.

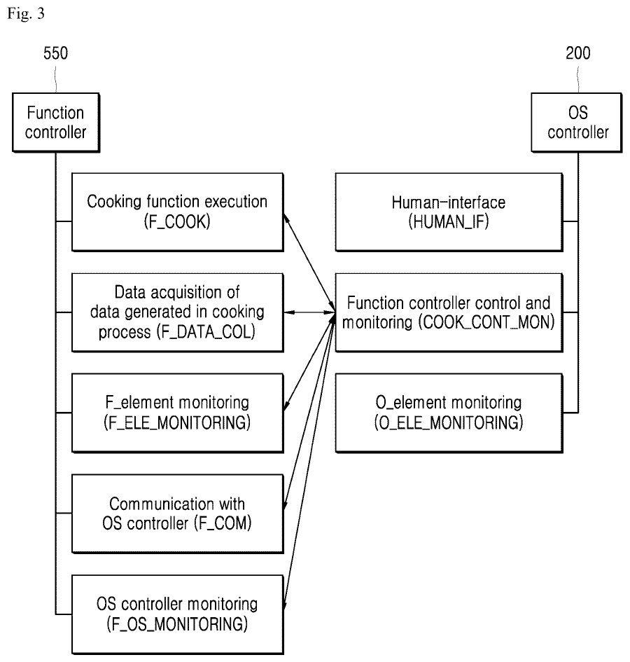

FIG. 3 is a diagram illustrating categories of functions performed by an OS controller and a function controller according to an embodiment of the present disclosure. Each function includes a case in which each of the controllers 200 and 550 performs a corresponding function.

Each of the controllers 200 and 550 may perform the functions simultaneously or sequentially.

The function controller 550 controls the functional unit 500 that provides a cooking function. The operating system (OS) controller 200 transmits a signal to the function controller 550. The function controller 550 instructs an operation of the functional unit 500. The operating system (OS) controller 200 controls the digital controller door 100 that provides a human interface.

The functions performed by the function controller 550 include cooking function execution F_COOK. In addition, the functions performed by the function controller 550 include data acquisition F_DATA_COL of data generated in the cooking process. In addition, functions performed by the function controller 550 include F_element monitoring F_ELE_MONITORING. In addition, functions performed by the function controller 550 include communication F_COM with the OS controller 200. In addition, functions performed by the function controller 550 include OS controller monitoring F_OS_MONITORING. The OS controller 200 and the function controller 550 may operate independently, and may inform the state or operation status of each component via transmission and reception of signals to and from each other.

In the cooking function execution F_COOK, the function controller 550 controls the cooking appliance function provider 560 so that the cooking appliance 1000 may perform cooking. Alternatively, in addition to cooking such as heating, a function in which the function controller 550 controls the operation of the inside lamp 570, the outside lamp 580, and the ventilation fan 590 may be included in the cooking function execution F_COOK.

The function of the data acquisition F_DATA_COL of the data generated in the cooking process is a function of the function controller 550 collecting or acquiring various result values calculated by the elements or the components of the functional unit 500 or data related to the current state in the cooking function execution F_COOK process.

The F_element monitoring (F_ELE_MONITORING) refers to a function in which the function controller 550 monitors elements or components of the functional unit 500. The function controller 550 may monitor whether each elements or component operates properly or whether each element or component operates according to a previous instruction to perform a function.

The communication F_COM function with the OS controller means that the function controller 550 provides data obtained in F_DATA_COL, F_ELE_MONITORING, etc. to the OS controller 200.

The OS controller monitoring F_OS_MONITORING function refers to a function in which the function controller 550 transmits a predetermined packet to the OS controller 200 to check whether the OS controller 200 is operating properly.

The F_COM and F_OS_MONITORING functions may be implemented as one function. That is, even when the cooking function is not performed, the function controller 550 transmits the data obtained through the F_ELE_MONITORING to the OS controller 200. The function controller 550 may check whether the OS controller 200 is in a normal state or an abnormal state based on whether the OS controller 200 has transmitted an acknowledgement (ACK) response to the transmitted data.

The functions performed by the OS controller 200 include a human-interface HUMAN_IF. In addition, the functions performed by the OS controller 200 include function controller control and monitoring COOK_CONT_MON. In addition, the functions performed by the OS controller 200 include O_element monitoring O_ELE_MONITORING. In this regard, one embodiment of function the controller control and monitoring COOK_CONT_MON is that the OS controller 200 transmits a predetermined signal to the function controller 550 so that the function controller 550 may control the functional unit 500, that is, the body 1010.

The human-interface HUMAN_IF function refers to a function in which the OS controller 200 outputs a user interface, such as various information or a menu necessary for controlling the cooking appliance, and receives a user's touch input thereto.

One embodiment of the function controller control and monitoring COOK_CONT_MON is that the OS controller 200 provides a signal to the function controller 550 so that the function controller 550 controls the operation of the functional unit 500, that is, the body 110. In addition, one embodiment of the function controller control and monitoring COOK_CONT_MON is that predetermined information collected by the function controller 550, for example, information necessary for monitoring the state or an operation status of the functional unit 500, that is, the body 110, is transmitted to the OS controller 200 in a form of a predetermined wired or wireless signal.

More specifically, when the user selects a specific cooking function in the human-interface HUMAN_IF function, the OS controller 200 may instruct the function controller 550 to execute the cooking function.

In addition, the OS controller 200 may perform monitoring to receive values of the operation states or cooking results of the elements or the components constituting the functional unit 500 from the function controller 550. All of these functions are included in the function controller control and monitoring COOK_CONT_MON. Accordingly, the function controller control and monitoring COOK_CONT_MON of the OS controller 200 is related to five functions of the function controller 550.

The O_element monitoring O_ELE_MONITORING refers to a function in which the OS controller 200 monitors the elements or the components of the digital controller door 100. The OS controller 200 may monitor whether each of the elements or the components operates properly, or whether each element component operates according to a previous instruction to perform a function.

As shown in FIG. 3, the function controller 550 and the OS controller 200 perform respective given functions independently but in association with each other. Accordingly, the function controller 550 checks whether the OS controller 200 operates normally or not in the process of performing the function, while the OS controller 200 checks whether the function controller 550 operates normally or not in the process of performing the function. When an abnormality occurs in an component of one of the function controller 550 and the OS controller 200, the other of the function controller 550 and the OS controller 200 may cope with this situation.

Hereinafter, a schematic outer appearance and configuration of a cooking appliance including the digital controller door 100 of the present disclosure will be described. This corresponds to one embodiment of the present disclosure, and a scheme and a direction in which the digital controller door 100 is opened may be implemented in various ways.

The present disclosure relates to a scheme for controlling a cooking appliance using a digital controller door disposed at a front surface of the cooking appliance.

According to the present disclosure, a door of a microwave oven disposed on top of an oven or a gas stove acts as a LCD screen (an embodiment of a display). The Android (an embodiment of a OS controller) of the LCD screen and the microcomputer (an embodiment of a function controller) of the microwave oven cooperate with each other. A LCD component operates according to various operating/external environments of the microwave oven or controls a specific function of the microwave oven.

The digital controller door of the present disclosure may be combined with the cooking appliance to open and close the inside of the cooking appliance. An embodiment of the cooking appliance of the present disclosure is a microwave oven. However, embodiments of the present disclosure is not limited thereto. An embodiment of the cooking appliance including the digital controller door of the present disclosure includes each of various cooking appliances which includes a door equipped with a display such as a LCD providing various user interfaces such as a touch screen, and is capable of storing and cooking food therein.

A display may be mounted on a front surface of a digital controller door provided in the cooking appliance of the present disclosure to provide various information to a user. The user may know the cooking state of the cooked food on the display.

In addition, when the display is connected to another home appliance to serve as a hub of the home appliances, the information other than cooking food may be obtained through the display. In addition, a command necessary for cooking and various other commands may be input to the display in a touch manner.

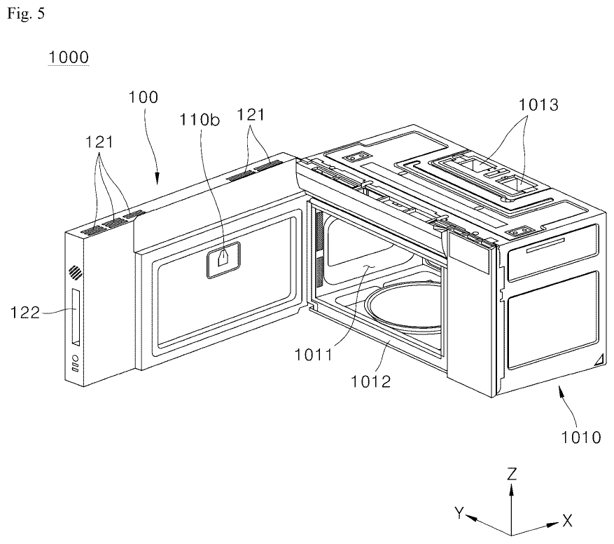

FIG. 4 is a perspective view illustrating a cooking appliance according to an embodiment of the present disclosure. FIG. 5 is a diagram illustrating a state in which the digital controller door 100 is opened in FIG. 4.

The cooking appliance according to the embodiment may be disposed at a position spaced apart from the heating cooking device in the vertical direction above a position where a heating-type oven, a gas stove, etc. are disposed.

Due to the arrangement of the cooking appliance, a user may conveniently use the heating cooking device including the cooking appliance. In addition, the cooking appliance may serve as a hood of the heating cooking device disposed under the cooking appliance. In this case, the cooking appliance may include components for use as the hood.

The cooking appliance may cook food using microwaves belonging to electromagnetic waves and/or heater heat. The cooking appliance may include the body 1010 in which a cavity 1011 is formed, and the digital controller door 100 configured to open and close the cavity 1011. The body 1010 is an embodiment of the functional unit 500 of FIG. 2 as described above. According to an embodiment of the present disclosure, the body 1010 may act in the same manner as the functional unit 500 may. Alternatively, according to an embodiment of the present disclosure, the components of the functional unit 500 may be implemented in the body 1010. Accordingly, in various embodiments, the functional unit 500 and the body 1010 may be interchangeable with each other.

Food to be cooked may be placed in the cavity 1011. The digital controller door 100 may be disposed in front of the cavity 1011 and pivotally mounted at the body 1010 to open and close the cavity 1011.

A ventilation hole 1013 for discharging air suctioned from a suction unit provided at a lower portion of the body 1010 to the outside may be provided at an upper portion of the body 1010. A suction unit may be provided at a lower portion of the body 1010 of the cooking appliance. Accordingly, the cooking appliance may serve as a hood that sucks air discharged from the heating cooking device disposed below the cooking appliance and discharges the air to the outside.

The body 1010 may further include a front panel 1012 provided along an edge of an inlet of the cavity 1011. One surface of the front panel 1012 faces one surface of a choke member when the digital controller door 100 is closed, thereby closing the cavity 1011.

The front panel 1012 may be constructed to surround the edge of the inlet of the cavity 1011 and protrude in a frontward direction and has a predetermined width. Accordingly, when the digital controller door 100 is closed, the edge portion of the digital controller door 100 and the cavity 111 may overlap each other.

Due to this structure, the front panel 1012 may seal the cavity 1011 in a state in which the digital controller door 100 has been closed, thereby preventing oil, moisture, oil vapor, etc. generated during the cooking process of the food placed in the cavity 1011 from being leaked out to the outside through the inlet of the cavity 1011.

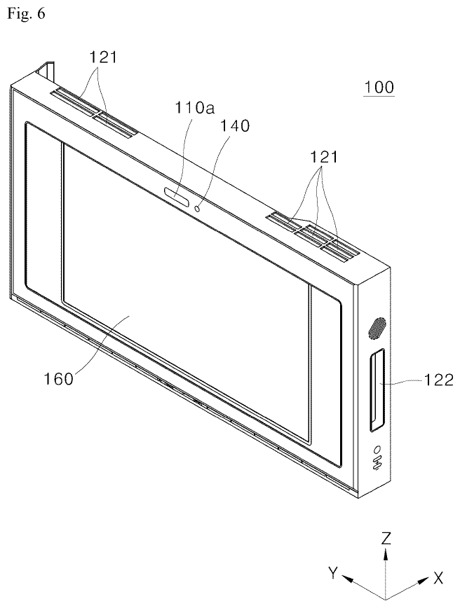

FIG. 6 is a perspective view illustrating a digital controller door of a cooking appliance according to an embodiment of the present disclosure.

The digital controller door 100 may include controller hardware (e.g., a hardware chip) or controller software (software including programs) that executes a predetermined algorithm and performs following tasks based on sensing results from various sensors disposed at the cooking appliance or the door and an operating state of the cooking appliance.

In FIGS. 4 to 6, a reference numeral 121 denotes a through hole through which air is introduced or discharged. A first camera 110a and the sensor 140 may be disposed on the front surface of the digital controller door 100. The sensor 140 includes a human sensor, an illuminance sensor, etc.

The display 160 is used to control the cooking appliance 1000 or displays an operation process in the cooking appliance 1000. The ventilation hole 1013 may include a suction portion defined at a lower end of the body 1010 and a discharge portion defined at an upper end of the body 1010. A handle 122 is disposed on one side of the digital controller door 100 such that the user may open and close the digital controller door 100 using the handle.

A second camera 110b may be disposed on an inner side surface of the digital controller door 100, and the second camera 110b may photograph the inside of the cavity 1011 to check the cooking state.

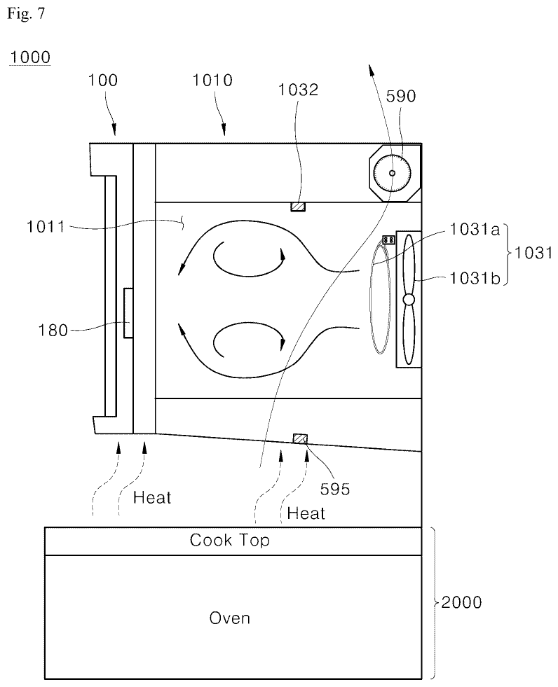

FIG. 7 is a schematic view illustrating a position where a cooking appliance is disposed according to an embodiment of the present disclosure. In FIG. 7, the flow of air is indicated by a solid line arrow, and the transfer direction of heat is indicated by a hidden line arrow. A heating cooking device 2000 may include, for example, an oven and a cooktop disposed on top of the oven.

The cooking appliance may include a convection-based heating device 1031 and a microwave generating device 1032 to heat food accommodated in the cavity 1011.

The convection-based heating device 1031 may generate heat to heat food, and the microwave generating device 1032 may generate microwaves to heat food. The user may select and operate one of the convection-based heating device 1031 or the microwave generating device 1032 to heat and cook food.

The convection-based heating device 1031 may include a convection heater 1031a and a convection fan 1031b. The convection heater may generate heat to heat food accommodated in the cavity 1011. The convection fan 1031b may force the air in the cavity 10 11 heated by the convection heater 1031a to flow in the cavity 1011.

When the convection fan 1031b operates, the heated air may be smoothly convectively circulated in the cavity 1011, and accordingly, heat is uniformly supplied to the entire cavity 1011, so that an entirety of the food accommodated in the cavity 1011 may be evenly cooked.

In order to prevent the display 160 provided in the digital controller door 100 from being overheated by the heated air coming up from the heating cooking device disposed under the cooking appliance, resulting in malfunction of or damage to the display 160, it is necessary to cool the display 160 and prevent external heat from being transferred to the display 160. The door fan 180 and the ventilation fan 590 may perform the above role.

The door fan 180 may be disposed inside the digital controller door 100. The door fan 180 may effectively cool the display 160 by flowing air toward the rear surface of the display 160.

In addition, the air flow discharged from the door fan 180 to the outside of the digital controller door 100 may form an air curtain to block the heat rising from the heating cooking device disposed under the cooking appliance.

The ventilation fan 590 may be disposed at a top of the body 1010 and may be disposed in a flow path of the ventilation hole 1013. The ventilation fan 590 may allow air coming up from the heating cooking device to flow to the ventilation hole 1013 to discharge the air to out of the cooking appliance.

Accordingly, when the ventilation fan 590 operates, a significant portion of the heated air coming up from the heating cooking device flows to the ventilation hole 1013 formed in the body 1010, and the flow rate of air heading to the display 160 of the digital controller door 100 may be relatively reduced. As a result, the flow rate of the heated air directed to the display 160 of the digital controller door 100 is reduced, thereby suppressing overheating of the display 160.

In order to block overheating of the display 160, it is necessary to appropriately use the door fan 180 and the ventilation fan 590. Since one of main purposes of the door fan 180 is to prevent the overheating of the display 160, the door fan 180 may operate in a low-speed rotation mode and a high-speed rotation mode based on the temperature condition of air approaching the digital controller door 100.

The door fan 180 has a small amount of air blown in the low-speed rotation mode and a large amount of air blown in the high-speed rotation mode. Therefore, the temperature of the display 160 may be effectively lowered by the door fan operating in the low-speed rotation mode when the temperature of the air is low and by the door fan operating in the high-speed rotation mode when the temperature of the air is high.

In order to reliably suppress the overheating of the display 160, it is advantageous to operate both the door fan 180 and the ventilation fan 590 and operate the door fan 180 in the high-speed rotation mode.

The thermistor 595 disposed at a bottom of the cooking appliance 1000 may sense the heat from the heating cooking device disposed under the cooking appliance 1000. In addition, the auto ventilation function may operate upon sensing the heat.

The functional unit 500 may include various components to measure the temperature. In the present disclosure, the thermistor 595 will be mainly described as the component to measure the temperature. However, embodiments of the present disclosure are not limited thereto, and all components for measuring the temperature may be included in the functional unit 500.

The thermistor 595 as a component of the functional unit 500 senses a temperature of an area in which the cooking appliance 1000 is disposed. For example, the thermistor 595 may detect a temperature change due to heat generated in a cooktop 2000. Alternatively, the thermistor 595 may detect heat generated in the cooking appliance 1000.

One or more thermistors 595 may be disposed in the cooking appliance 1000. The function controller 550 may continuously monitor the temperature sensed by the thermistor 595 by performing the F_element_monitoring F_ELE_MONITORING. In both a situation in which the functional unit 500 performs cooking and a situation in which cooking is not performed thereby, the function controller 550 may monitor the thermistor 595.

When the thermistor 595 malfunctions or fails, the function controller 550 may immediately notify the OS controller 200 that the thermistor 595 malfunctions or fails.

The function controller 550 performs the F_element monitoring in S1. In the monitoring process, the function controller 550 may monitor the state of the thermistor 595. By monitoring the state of the thermistor 595, the digital controller door 100 may provide safety in determining the occurrence of heat or moisture affecting the display 160.

Hereinafter, when the function controller 550 confirms the thermistor error based on an output value of the thermistor 595 and notifies the OS controller 200 of the thermistor error, the OS controller 200 starts the thermistor error response process in response to the notified thermistor error.

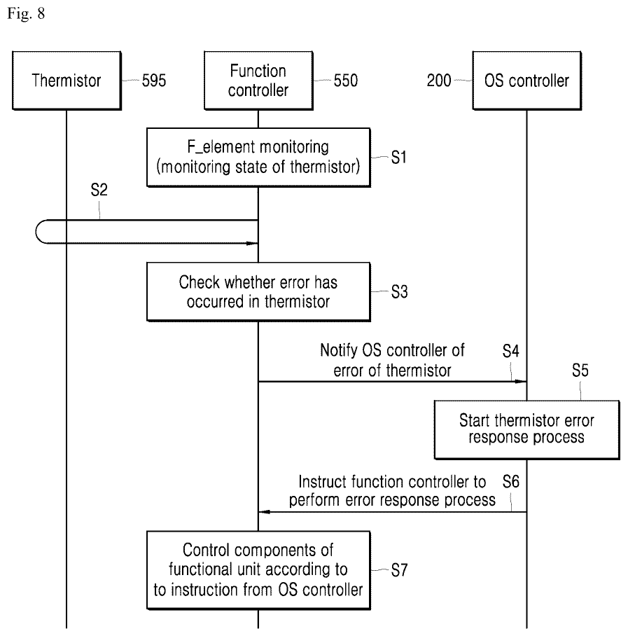

FIG. 8 is a diagram illustrating a process in which a cooking appliance monitors a state of a thermistor and responds to an error of the thermistor, according to an embodiment of the present disclosure. FIG. 8 shows a process in which the function controller 550 notifies the OS controller 200 of a thermistor error and then receives an instruction to control the components of the functional unit 500 from the OS controller 200.

The function controller 550 controlling the operation of the functional unit 500 performs the F_element_monitoring F_ELE_MONITORING. In this process, the function controller 550 monitors the state of the thermistor 595 in S1. To monitor the state of the thermistor 595, the function controller 550 may obtain specific state information from the thermistor 595 in S2. Acquisition of the specific state information will be described later.

The function controller 550 checks whether an error has occurred in the thermistor 595 using the obtained information in S3. When it is determined that the error has occurred, the function controller 550 notifies the OS controller 200 of the occurrence of the error of the thermistor 595 in S4. Upon being notified of the occurrence of the error of the thermistor 595, the OS controller 200 starts the thermistor error response process in S5.

The thermistor error response process includes the output of visual/auditory information to inform the user that the thermistor error has occurred. In addition, the OS controller 200 instructs the function controller 550 to perform the error response process in response to the occurrence of the error in S6.

The function controller 550 controls components of the functional unit 500 according to an instruction from the OS controller 200 in S7. For example, the function controller 550 cancels an operation of components that should be stopped according to an error of the thermistor 595. Alternatively, the function controller 550 operates a component that should operate among the components of the functional unit 500 according to the instruction of the OS controller 200.

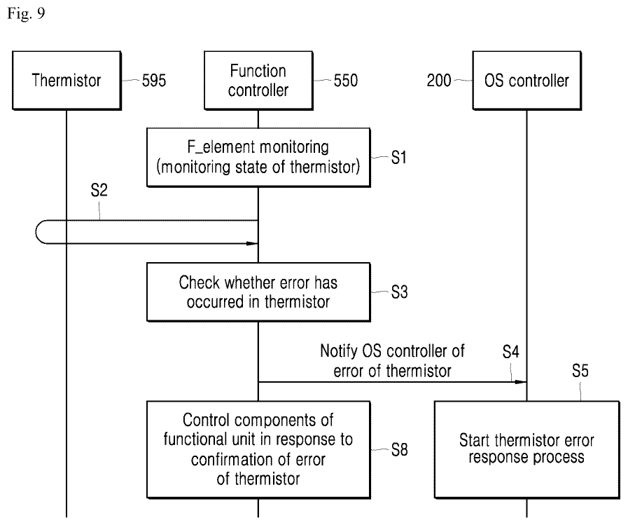

FIG. 9 is a diagram illustrating a process in which a cooking appliance monitors a state of a thermistor and responds to an error thereof, in accordance with another embodiment of the present disclosure. FIG. 9 shows a process in which the function controller 550 notifies the OS controller 200 of a thermistor error, and the function controller 550 controls components of the functional unit 500 in response to the thermistor error.

Unlike FIG. 8, when the error occurs in the thermistor 595, the function controller 550 controls the components of the functional unit 500 without the instruction from the OS controller 200.

Descriptions about S1 to S5 in FIG. 9 are replaced with the descriptions of FIG. 8 as described above.

When the error of the thermistor 595 is confirmed in S3, the function controller 550 notifies the OS controller 200 of the error in S4. In addition, separately from operation S4, the function controller 550 confirms the error of the thermistor 595 and then controls the components of the functional unit 500 in S8. For example, the function controller 550 cancels an operation of components that should be stopped according to an error of the thermistor 595. Alternatively, the function controller 550 operates a component that should operate among the components of the functional unit 500 in order to cope with the occurrence of the thermistor 595 error.

The function controller 550 may perform S8 immediately after S3. For example, after performing S3 and S8, the notification operation of S4 may be performed.

FIGS. 8 and 9 are differed from each other depending on whether the control of operating or stopping the components of the functional unit 500 in response to the thermistor 595 error is instructed by the OS controller 200 (FIG. 8) or by a programmed internal logic of the function controller 550 (FIG. 9).

Alternatively, even before the instruction from the OS controller 200 is sent, the function controller 550 may operate the components of the functional unit 500 or cancel the operation thereof under the programmed internal logic of the function controller 550.

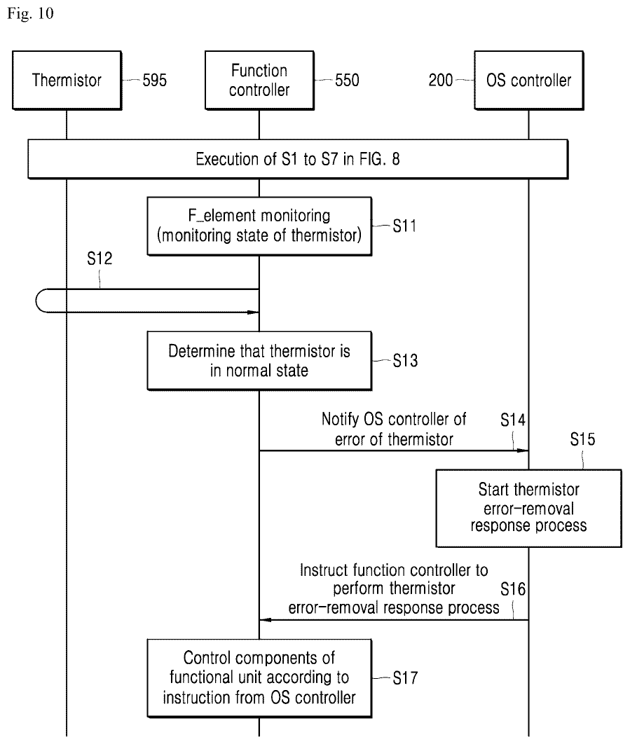

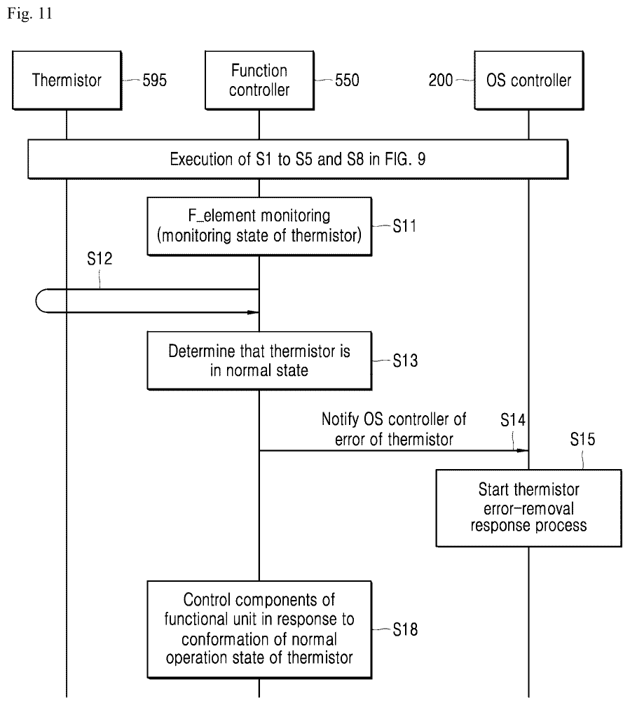

FIGS. 10 and 11 are diagrams showing a process in which the function controller 550 notifies the normal state of the thermistor 595 of the OS controller 200 when the error of the thermistor 595 has been removed and thus the thermistor 595 operates normally, and, then, the function controller 550 controls the components of the functional unit. The meaning of error is removed is that error is resolved or situation of error is resolved, or error-related malfunction is cured.

FIG. 10 is a diagram illustrating a process responding to a situation in which an error of a thermistor is solved and thus the thermistor operates normally, according to an embodiment of the present disclosure. FIG. 10 corresponds to the process of FIG. 8.

After an error of the thermistor 595 occurs, the function controller 550 performs the F_element_monitoring F_ELE_MONITORING. In this process, the state of the thermistor 595 is monitored in S11. To monitor the state of the thermistor 595, the function controller 550 may obtain specific state information from the thermistor 595 in S12.

The function controller 550 determines that the thermistor 595 is in a normal state using the acquired information in S13. When it is determined that the error of the thermistor 595 is solved, the function controller 550 notifies the OS controller 200 that the thermistor 595 is in a normal state in S14. Upon receiving the notification that the thermistor 595 is in the normal state, the OS controller 200 starts a thermistor error-removal response process in S15.

The thermistor error-removal response process includes outputting visual/auditory information to inform the user that the thermistor error has been removed and operates in a normal state. In addition, the OS controller 200 instructs the function controller 550 to perform the reerror-removal response process in response to the error removal in S16.

The function controller 550 controls the components of the functional unit 500 according to the instruction of the OS controller 200 in S17. For example, the function controller 550 may instruct a component that should re-operate according to the error removal of the thermistor 595 to re-operate.

FIG. 11 is a diagram illustrating a process responding to a situation in which an error of a thermistor is solved and thus the thermistor operates normally, according to another embodiment of the present disclosure. FIG. 11 corresponds to the process of FIG. 9. Unlike FIG. 10, in FIG. 11, when the error of the thermistor 595 has been removed, the function controller 550 controls the components of the functional unit 500 without the instruction from the OS controller 200.

Descriptions about S11 to S15 refer to the descriptions made above with reference to FIG. 10.

When the error of the thermistor 595 has been removed and it is confirmed that the error is in the normal state in S13, the function controller 550 notifies the OS controller 200 of this in S14. In addition, separately from operation S14, the function controller 550 conforms the normal operation state of the thermistor 595 and then controls the components of the functional unit 500 in S18. For example, the function controller 550 may indicate an operation of components that need to be re-operated according to the error removal of the thermistor 595.

FIGS. 10 and 11 are different from each other depending on whether the start of control of the component of the functional unit 500 is indicated by the OS controller 200 or by the programmed internal logic of the function controller 550. That is, FIGS. 10 and 11 are different from each other depending on whether the control for operating or stopping the components of the functional unit 500 as the error of the thermistor 595 has been removed is indicated by the OS controller 200 (FIG. 10) or by the programmed internal logic of the function controller 550 (FIG. 11).

Alternatively, even before the instruction from the OS controller 200 is sent, the function controller 550 may operate the components of the functional unit 500 or cancel the operation thereof, under the programmed internal logic of the function controller 550.

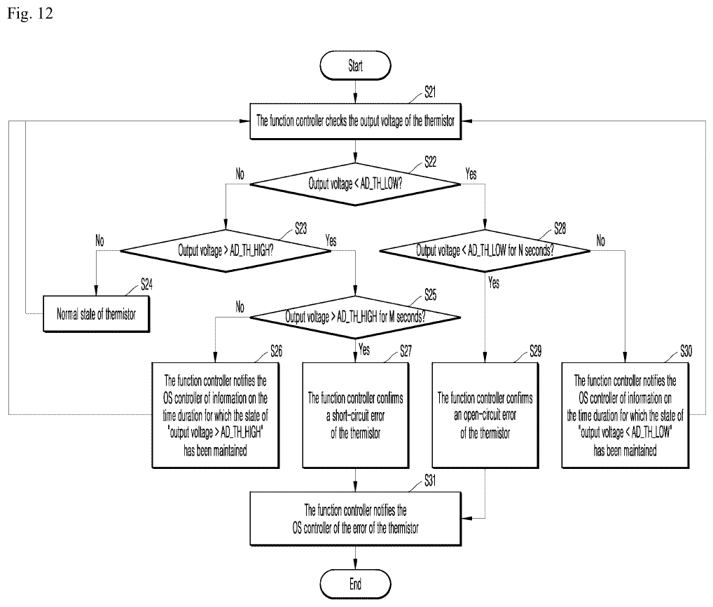

FIG. 12 is a diagram illustrating a process in which a function controller monitors an operation state of a thermistor according to an embodiment of the present disclosure.

The function controller 550 checks the output voltage of the thermistor 595 in S21. Operation S21 may always be performed separately from the cooking state of the functional unit 500. That is, the function controller 550 may continuously check the output voltage of the thermistor 595. An embodiment of the output voltage is an AD value as a result of converting a value (analog value) calculated by the thermistor 595 into a digital value.

The function controller 550 checks whether the output voltage of the thermistor 595 is smaller than the lowest reference voltage AD_TH_LOW in S22. When the output voltage is equal to or greater than the lowest reference voltage AD_TH_LOW, the function controller 550 checks whether the output voltage of the thermistor 595 is greater than the highest reference voltage AD_TH_HIGH in S23.

When the output voltage is greater than the lowest reference voltage AD_TH_LOW and the output voltage is smaller than the highest reference voltage AD_TH_HIGH in operations S22 and S23, the thermistor 595 is in a normal state in S24. Accordingly, the function controller 550 continuously checks the output voltage of the thermistor 595 in S21.

Otherwise, when the output voltage of the thermistor 595 is smaller than the lowest reference voltage AD_TH_LOW at operation S22, the function controller 550 proceeds to operation S28.

The function controller 550 continuously checks the output voltage of the thermistor 595 and checks whether a state in which the output voltage of the thermistor 595 is lower than the lowest reference voltage AD_TH_LOW has been maintained for the lowest reference time duration (e.g., N seconds) (check whether the output voltage <AD_TH_LOW″) in S28.

When a state in which the output voltage value of the thermistor 595 is lower than a predetermined reference AD_TH_LOW (for example, 5) has been maintained for N seconds (for example, 5 seconds, 10 seconds, etc.), the function controller 550 confirms an open-circuit error of the thermistor 595 in S29, and the function controller 550 notifies the OS controller 200 of the error of the thermistor 595 in S31. In this case, the function controller 550 may notify the OS controller 200 of a type of the thermistor error (short/open), the time duration information for which the thermistor error state has been maintained, etc.

Based on a result of the function controller 550 continuously checking the output voltage of the thermistor 595 for the lowest reference time duration (e.g., N seconds) at S28, it may be determined that the output voltage is higher than or equal to the AD_TH_LOW again (S28—No). In this case, the function controller 550 notifies the OS controller 200 of information on the time duration for which the state of “output voltage <AD_TH_LOW” has been maintained in S30.

For example, when a state in which the output voltage of the thermistor 595 is lower than the AD_TH_LOW has been maintained for 6 seconds in an embodiment in which the lowest reference time duration (e.g., N seconds) is 10 seconds, the function controller 550 notifies the OS controller 200 of information related thereto in S30. The OS controller 200 records the related information so that the function controller 550 may adjust the value of the lowest reference voltage AD_TH_LOW, or the value of the monitoring time duration (N seconds) in checking the output voltage of the thermistor 595 later. After operation S30, the function controller 550 proceeds to operation S21.

Otherwise, when the output voltage of the thermistor 595 is greater than the highest reference voltage AD_TH_HIGH at operation S23, the function controller 550 executes operation S25.

The function controller 550 continuously checks the output voltage of the thermistor 595 to check whether a state in which the output voltage of the thermistor 595 is greater than the highest reference voltage AD_TH_HIGH has been maintained for the highest reference time duration (e.g., M seconds) (check whether “output voltage >AD_TH_HIGH”) in S25.

When a state in which the output voltage value of the thermistor 595 exceeds the reference value AD_TH_HIGH (e.g., 250) has been maintained for the highest reference time duration (e.g., M secs, for example, for 5 seconds, 10 seconds, etc.), the function controller 550 confirms a short-circuit error of the thermistor 595 in S27, and thus the function controller 550 notifies the OS controller 200 of the error of the thermistor 595 in S31.

Otherwise, when, based on the result of the function controller 550 continuously checking the output voltage of the thermistor 595 at S25, a state in which the output voltage of the thermistor 595 is lower than or equal to the AD_TH_HIGH has been maintained within the highest reference time duration (e.g., M seconds) (S25—No), the function controller 550 notifies the OS controller 200 of information on the time duration for which the state of “output voltage >AD_TH_HIGH” has been maintained in S26.

For example, when a state in which the output voltage of the thermistor 595 is greater than the AD_TH_HIGH has been maintained for 7 seconds in an embodiment in which the highest reference time duration (e.g., M seconds) is 10 seconds, the function controller 550 notifies the OS controller 200 of information related thereto in S26. The OS controller 200 records the related information so that the function controller 550 may adjust the value of the highest reference voltage AD_TH_HIGH, or the value of the monitoring time duration (M seconds) in checking the output voltage of the thermistor 595 later. After S26, the function controller 550 executes operation S21.

One embodiment of the function controller 550 of the functional unit 500 is a microcomputer. The function controller 550 may always detect the output value of the thermistor 595 regardless of the current cooking situation or cooking state. When a state in which the output value (AD value) is lower than a specific reference (e.g., 5) has been maintained for a specific time duration (e.g., 10 seconds), the function controller 550 may determine the state of the thermistor 595 as an open-circuit error. When a state in which the output value (AD value) is higher than a specific reference (e.g., 250) has been maintained for a specific time duration (e.g., 10 seconds), the function controller 550 may determine the state of the thermistor 595 as a short-circuit error.

When a short circuit occurs in the thermistor 595, the input voltage thereto is directly output. When the thermistor 595 has an open circuit (is broken), a voltage is input thereto, but there may be no output therefrom. Accordingly, the function controller 550 may check whether the thermistor 595 has failed based on the output voltage of the thermistor 595.

When the embodiment of FIG. 9 is applied, the function controller 550 may perform the error notification as presented in S31 and subsequently perform the operation S8 of controlling the components of the functional unit 500.

At S31, the function controller 550 may notify the OS controller 200 of the output value of the thermistor and the time duration information for which the output value has been maintained.

The process of FIG. 12 is summarized as follows.

When a state in which the output value of the thermistor is lower than the lowest reference voltage has been maintained for N seconds or larger in S28 or S29 or a state in which the output value of the thermistor is higher than the highest reference voltage has been maintained for M seconds or greater in S25 or S27, the function controller 550 confirms the thermistor error in S27 or 29. In this regard, N and M may be predefined values and may be set based on a second unit, a minute unit, or a millisecond unit (ms).

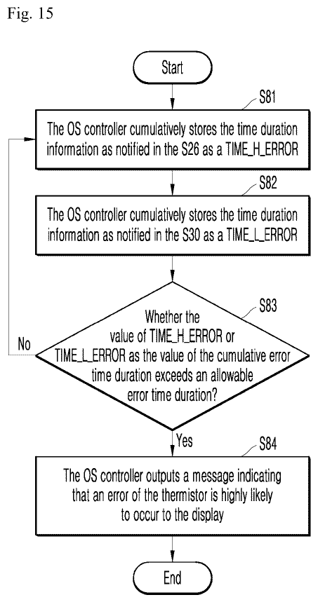

The function controller 550 may notify the OS controller 200 of the time duration for which a state in which the output value of the thermistor 595 is lower than the lowest reference voltage has been maintained or the time duration for which a state in which the output value of the thermistor 595 is higher than the highest reference voltage has been maintained in S26, S30, or S31. An embodiment in which the function controller 550 notifies the time duration is related to FIG. 15, and will be described later with reference to FIG. 15.

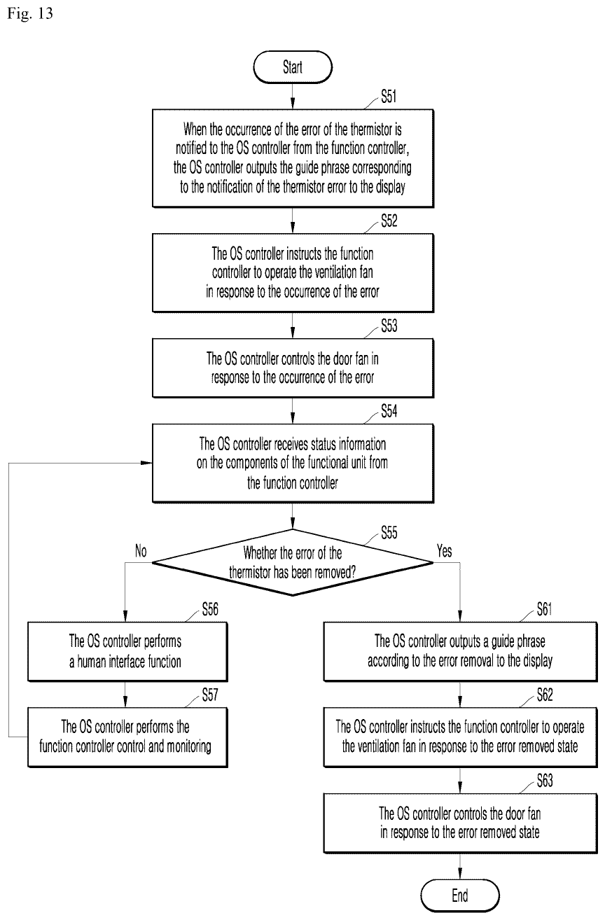

FIG. 13 is a diagram showing an error response process and an error-removal response process of an OS controller according to an embodiment of the present disclosure.

The OS controller 200 outputs a guide phrase corresponding to the notification of the thermistor error to the display 160, and controls operations of the ventilation fan 590 and the door fan 180 of the functional unit 500. This will be described below in details.

When the occurrence of the error of the thermistor 595 is notified to the OS controller 200 from the function controller 550 (for example, S31 of FIG. 12), the OS controller 200 outputs the guide phrase corresponding to the notification of the thermistor error to the display 160 in S51. In addition, the OS controller 200 controls the speaker/microphone 130 so that a predetermined voice guidance message may be output through the speaker.

In operation S51, the display 160 may display an error of the thermistor 595 in a pop-up form. In this case, when the user who has checked the pop-up presses the “OK” button, the pop-up displayed on the display 160 may disappear.

Alternatively, after a predetermined time duration has elapsed even after the displayed pop-up disappears, the display 160 may display the error of the thermistor 595 in the form of a pop-up again. The OS controller 200 may repeatedly display the pop-up on the display 160 until the error of the thermistor 595 has been removed.

The display 160 may output an on-going notification. The OS controller 200 may control the display 160 such that the output notification disappears when the error of the thermistor 595 has been removed.

Next, the OS controller 200 may instruct the function controller 550 to operate the ventilation fan 590 in response to the occurrence of the error in S52. For example, the OS controller 200 may instruct the function controller 550 to operate the ventilation fan 590 at a specific level.

The specific level may be set based on an operation level of the ventilation fan 590. For example, when the ventilation fan 590 operates at four levels including an off level, the low level, the middle level, and the high level, the OS controller 200 may instruct the function controller 550 to operate the ventilation fan 590 at the middle level.

In addition, the OS controller 200 may control the door fan 180 in response to the occurrence of the error in S53. For example, when the door fan 180 operates at four levels including an off level, the low level, the middle level, and the high level. In this case, the OS controller 200 may control the door fan 180 to operate at the high level.

A function performed by the functional unit in the process of S51 to S53, for example, a state in which the cooking appliance function provider 510 performs cooking, a state in which the inside lamp 570 or the outside lamp 580 is turned on or off, may be maintained as it is. That is, in addition to controlling the operation of the ventilation fan 590, the operations of the components of the functional unit 500 may not be stopped, but may be continuously maintained. In addition to controlling the operation of the ventilation fan 590, the components of the functional unit 500 may maintain a normal operation state thereof.

Thereafter, the OS controller 200 receives status information on the components of the functional unit from the function controller 550 in S54. Upon determination that the error of the thermistor has been removed as a result of the reception of the status information (S55—Yes), the OS controller 200 outputs a guide phrase according to the error removal to the display 160 in S61.

The OS controller 200 may remove the pop-up output in the operation S51 from the display 160. Alternatively, when the pop-up has been already removed, the OS controller 200 may output a phrase indicating that the error of the thermistor 595 has been removed on the display 160.

Next, the OS controller 200 may instruct the function controller 550 to operate the ventilation fan in response to the error removed state in S62. For example, the ventilation fan may be turned off or operate at a low level according to the instruction. Alternatively, when the thermistor 595 operates normally due to the error removal, the OS controller 200 may control the operation of the ventilation fan 590 based on the temperature sensed by the thermistor 595.

In addition, the OS controller 200 may control the door fan 180 in response to the error removed state in S63. The OS controller 200 may control the operation of the door fan 180 based on the operation state of the display 160, the temperature detected by the thermistor 595, or whether the cooking appliance function provider 560 performs the cooking. Accordingly, when the thermistor 595 operates normally due to the error removal, the OS controller 200 may control the operation of the door fan 180 based on the temperature information detected by the thermistor 595.

When the error of the thermistor is not removed in the S55 (S55—No), the OS controller 200 performs a human interface function in S56 and also performs the function controller control and monitoring COOK_CONT_MON in S57.

In FIG. 13, the digital controller door 100 may notify the user of the occurrence of the error of the thermistor or the removed state of the error of the thermistor using an auditory message (voice message, beep sound, etc.) in addition to a visual message (pop-up message, image, etc.).

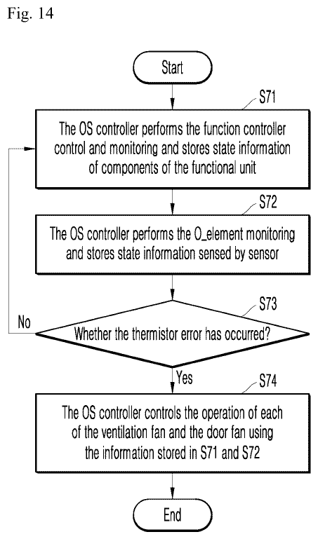

FIG. 14 is a diagram illustrating a process in which an OS controller uses a past history in controlling operations of respective components, according to an embodiment of the present disclosure.

FIG. 14 includes an embodiment that reflects each previous operation level in controlling the operation of the ventilation fan 590 and the door fan 180 in response to the thermistor error described in FIG. 13.

The OS controller 200 performs the function controller control and monitoring COOK_CONT_MON and stores state information of components of the functional unit 500 in S71. For example, the OS controller 200 may store information on a temperature sensed by the thermistor 595, an operation state of the ventilation fan 590 (whether the operation state is off or the operation level is at a low/middle/high level), whether the outside lamp 580 or the inside lamp 570 is turned on, whether the cooking appliance function provider 560 is cooking, etc.

In addition, the OS controller 200 performs the O_element monitoring and stores state information of components of the digital controller door. For example, the OS controller 200 stores information sensed by the sensor 140 in S72. In addition, the OS controller 200 stores information on the temperature applied to the digital controller door 100 or information on whether a person is around the digital controller door 100.

When it is determined that the thermistor error has occurred in S73, the OS controller 200 controls the operation of each of the ventilation fan 590 and the door fan 180 using the information stored in the operations S71 and S72 in S74.

For example, it is assumed that an operation state of the ventilation fan 590 stored by the OS controller 200 is an off state before an error of the thermistor 595 occurs. Thereafter, when the error occurs in the thermistor 595, the OS controller 200 may instruct the function controller 550 to change the operation level of the ventilation fan 590 to a middle level.

When an error of the thermistor 595 occurs in a state in which an operation level of the ventilation fan 590 stored by the OS controller 200 is low before the error of the thermistor 595 occurs, the OS controller 200 may instruct the function controller 550 to change the operation level of the ventilation fan 590 to a high level.

In this way, the operation state is stored before the error of the thermistor 595 occurs. Thus, the OS controller 200 may control the operation of the ventilation fan 590 based on a previous operation level even in a state in which the temperature information may not be identified after the error of the thermistor 595 occurs.

Similarly, the OS controller 200 may use information before the occurrence of the error in the thermistor 595 in controlling the operation of the door fan 180.

For example, it is assumed that the operating level of the door fan 180 stored by the OS controller 200 is a low level before the error of the thermistor 595 occurs. Thereafter, when an error of the thermistor 595 occurs, the OS controller 200 may instruct the operation level of the door fan 180 from the low level to the middle level.

When an error of the thermistor 595 occurs in a state in which an operation level of the door fan 180 stored by the OS controller 200 is a middle level before an error of the thermistor 595 occurs, the OS controller 200 may instruct the operation level of the door fan 180 from the middle level to the high level.

In addition, the OS controller 200 cumulatively stores temperature information sensed by the sensor 140 in controlling the operating level of the door fan 180. When an error occurs in the thermistor 595, the operation level of the door fan 180 may be set using the previously stored temperature information.

In this way, the operation level may be stored before the error of the thermistor 595 occurs. Thus, the OS controller 200 may control the operation of the door fan 180 based on the previous operation level even in a state in which the temperature information may not be identified after the error of the thermistor 595 occurs.

When the embodiment of FIG. 14 is applied, the OS controller 200 may control the operation of the components after the error occurs, based on the operation states of the components immediately before the error occurs in the thermistor 595.

The OS controller 200 may control the components of the cooking appliance 1000 using a temperature value detected by the thermistor 595 before an error of the thermistor 595 occurs. For example, when the temperature sensed by the thermistor 595 is 40 degrees C., and then, after M or N seconds have elapsed, the error of the thermistor 595 may be notified from the function controller 550 to the OS controller 200, the OS controller 200 may predict that the temperature has increased by a predetermined amount or larger, based on 40 degrees C., and may control the operation of the ventilation fan 590 or the door fan 180.

Similarly, for example, when the temperature sensed by the thermistor 595 is 20 degrees C., and then, after M or N seconds have elapsed, the error of the thermistor 595 may be notified from the function controller 550 to the OS controller 200, the OS controller 200 may predict that the temperature has increased by a predetermined amount or larger, based on 20 degrees C., and may control the operation of the ventilation fan 590 or the door fan 180.

The embodiment of FIG. 14 may be summarized as follows. The OS controller 200 stores state information of components of the functional unit 500 and state information of components of the digital controller door 100 in S71 and S72. The OS controller 200 uses the state information stored in the S71 and the S72 to control the operation of the ventilation fan 590 and the door fan 180 of the functional unit 500 in S74.

More specifically, upon receiving the thermistor error notification, the OS controller 200 may increase the operation level of the ventilation fan or the door fan set before the thermistor error notification.

FIG. 15 is a diagram illustrating a process in which an OS controller responses to an cumulative error state of a thermistor according to an embodiment of the present disclosure. FIG. 15 corresponds to the process of FIG. 12. The OS controller 200 cumulatively stores the time duration notified from the function controller 550 in FIG. 12. When the cumulative time duration exceeds an allowable error time duration, the OS controller 200 outputs a guide phrase to the display 160. This will be described below in details.

A process related to S26 and S30 of FIG. 12 will be described. The OS controller 200 cumulatively stores the time duration information (the time duration for which “the output voltage >AD_TH_HIGH” state has been maintained) as notified in the S26 as a TIME_H_ERROR in S81. Similarly, the OS controller 200 cumulatively stores the time duration information (the time duration for which “the output voltage <AD_TH_LOW” state has been maintained) as notified in the S30 as a TIME_L_ERROR in S82.

The OS controller 200 checks whether the value of TIME_H_ERROR or TIME_L_ERROR as the value of the cumulative error time duration exceeds the allowable error time duration in S83. When the value of TIME_H_ERROR or TIME_L_ERROR does not exceed the allowable error time duration, the OS controller 200 performs another function and performs S81 and S82 when the notification of S26 or S30 occurs.

When the value of TIME_H_ERROR or TIME_L_ERROR exceeds the allowable error time duration in S83, the OS controller 200 outputs a message indicating that an error of the thermistor 595 is highly likely to occur to the display 160 in S84.

For example, as shown in FIG. 12, even when the time duration for which the thermistor 595 outputs an abnormal result is smaller than M or N seconds, the time duration for which the thermistor 595 outputs the abnormal result may be continuously accumulated. This means that the thermistor 595 is not normal.

Accordingly, when the time durations for which the open-circuit error or the short-circuit error of the thermistor 595 occurs are accumulated and thus the cumulative value thereof exceeds the allowable error time duration, the OS controller 200 outputs the possibility of occurrence of the thermistor error to the display 160 so that the user may check the thermistor 595.

In FIG. 15, the time duration for which the error occurs is cumulatively stored as the TIME_H_ERROR or the TIME_L_ERROR, respectively. However, embodiments of the present disclosure is not limited thereto. That is, according to another embodiment of the present disclosure, the time duration for which “the output voltage >AD_TH_HIGH” state has been maintained and the time duration for which “the output voltage <AD_TH_LOW” state has been maintained may be cumulatively stored as one variable.

In addition, the TIME_H_ERROR or TIME_L_ERROR as the cumulative value of the time durations for which the error occurrence has been maintained may be periodically reset. The OS controller 200 may set the value of TIME_H_ERROR or TIME_L_ERROR to 0 per an interval such as 1 month or half a year.

In addition, the OS controller 200 may increase or decrease the interval per which the value of TIME_H_ERROR or TIME_L_ERROR is reset, based on the use time of the cooking appliance 1000. For example, in the case of the cooking appliance 1000 that has just started to be used, an error of the thermistor 595 is unlikely to occur. Thus, the OS controller 200 may set the interval per which the value of TIME_H_ERROR or TIME_L_ERROR is reset to 3 months.

Otherwise, there is a high possibility that an error of the thermistor 595 may occur in the cooking appliance 1000 that has been used for one year. In this case, the OS controller 200 may set the interval per which the value of TIME_H_ERROR or TIME_L_ERROR is reset to one year.

Alternatively, in another embodiment of the present disclosure, the OS controller 200 may increase or decrease the allowable error time duration based on the use time of the cooking appliance 1000. For example, in the case of the cooking appliance 1000 that has just started to be used, an error of the thermistor 595 is unlikely to occur. Thus, the OS controller 200 may set the allowable error time duration to a greater value.

Otherwise, there is a high possibility that an error of the thermistor 595 may occur in the cooking appliance 1000 that has been used for one year. In this case, the OS controller 200 may set the allowable error time duration to a smaller value.

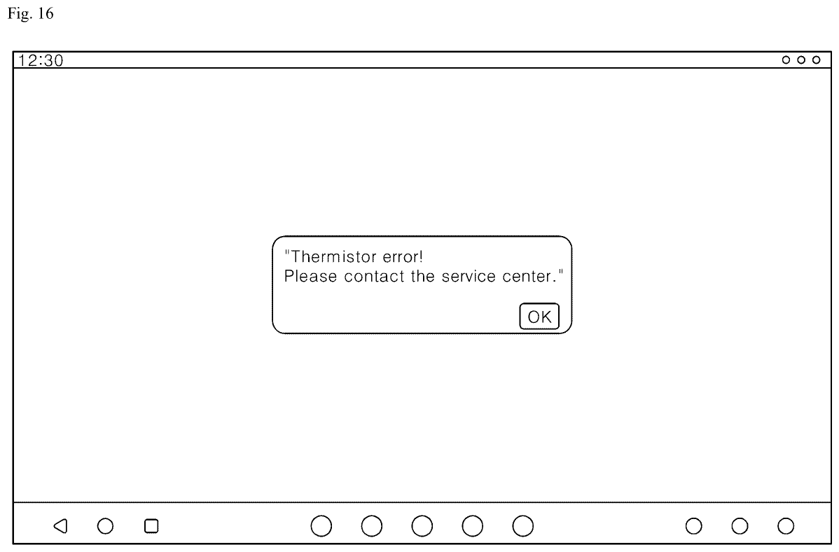

FIG. 16 is a diagram showing a thermistor error message displayed on a display according to an embodiment of the present disclosure.

When the thermistor error is identified, the OS controller 200 outputs a guide phrase to the display 160 as described in S51 of FIG. 13. The outputted phrase is “Thermistor error! Please contact the service center.” This phrase includes information informing the user that the user may check the error and cope therewith. Alternatively, a message indicating that cooking is canceled or a specific function is stopped due to the thermistor error may also be displayed on the display 160.

When the thermistor error has been removed, the OS controller 200 may output a phrase such as “the thermistor error has been removed and the cooking appliance may can operate” on the display 160.

When the thermistor 595 detects the temperature, the ventilation fan 590 may automatically operate based on the detected temperature. This is referred to as an auto ventilation. The function controller 550 may automatically execute the auto ventilation function based on the temperature sensed by the thermistor 595 to prevent component failure or damage. That is, when the function controller 550 detects that the temperature of the thermistor is equal to or higher than a predetermined temperature, the function controller may execute the auto-ventilation function, and accordingly, may notify the OS controller 200 of information indicating that the auto-ventilation is activated.

In response to reception of the notification, the OS controller 200 may display an auto ventilation operation state on the display 160.

The OS controller 200 may display, on the display 160, a pop-up message indicating that the auto ventilation is being activated when the temperature sensed by the thermistor 595 reaches a predetermined temperature condition. This is a function that the user may not cancel or change arbitrarily. Accordingly, the OS controller 200 may display information indicating that the auto ventilation operation is being performed on the display 160 and may also output a message indicating that the auto ventilation operation cannot be changed or cancelled. The user may not set a timer for this auto ventilation operation. The ventilation fan 590 is terminated when the auto ventilation has been terminated even though the user turns off the cooking appliance 1000 on the display 160.

In addition, the auto-ventilation may be executed when a timer is set. In this case, the OS controller 200 may display a remaining timer time on the display 160 when the auto-ventilation operation has been terminated. In addition, when the auto-ventilation operation ends and the timer time ends, the ventilation fan 590 is also turned off.

In one example, when the user starts to operate the ventilation fan 590 during the cooking, an operation intensity of the ventilation fan 590 may not be set to a turbo level (strong intensity). After the cooking has been finished, the ventilation fan 590 may operate in the turbo level as long as the previously set ventilation fan intensity is the turbo level.

As described above, the auto ventilation function refers to a function provided to protect components of the cooking appliance 1000. Accordingly, when an error occurs in a process in which the function controller 550 cooperates with the OS controller 200, the operations of other components of the functional unit 500 may be canceled, but the operation of the ventilation fan 590 executing the auto ventilation may be maintained. Similarly, even when there is no instruction from the OS controller 200, the function controller 550 may automatically start or end the operation of the ventilation fan 590 based on the temperature sensed by the thermistor 595.

Accordingly, when an error of the thermistor occurs during the execution of the auto ventilation function, the OS controller 200 or the function controller 550 may maintain the operation of the ventilation fan. To this end, the temperature sensed by the thermistor 595 during a previous normal operation period may be used.

When an embodiment of the present disclosure is applied, the cooking appliance including the digital controller door provides a logic for detecting a thermistor failure. Hereinafter, an example in which an embodiment of the function controller 550 is a microcomputer, and an embodiment of the OS controller 200 is an Android (board) will be mainly described below.

An open-circuit or short-circuit error may occur in the thermistor. Therefore, the Android (board) and the microcomputer may always check whether the thermistor is faulty.

The Android (board) and the microcomputer can always detect the state of the thermistor regardless of the state of the cooking. In an embodiment, the microcomputer may detect the state of the thermistor and notify the Android (board) of the detected state.

In order to check the state of the thermistor, the microcomputer may check whether the thermistor is faulty based on the output voltage of the thermistor. In an embodiment, the input voltage to the thermistor is directly output therefrom when the thermistor is in a short-circuit state. When the thermistor is in an open-circuit state (broken), the voltage is input to the thermistor but there is no output therefrom. Accordingly, the microcomputer may monitor the output voltage and check the state of the thermistor based on the output voltage. In another example, the Android (board) and the microcomputer may check the status of the thermistor in various ways.

In an embodiment, a MC board (microcomputer board) may detect the output voltage or the input voltage of the thermistor and determine whether the thermistor has failed based on the detection result.

In an embodiment, the change in resistance of the thermistor may be obtained as a voltage value via AD. In response to that the voltage value obtained via the AD is maintained at a value below a predetermined reference value, the error of the thermistor may be determined as an open-circuit error. In addition, the MC board (microcomputer board) may determine the error of the thermistor as a short-circuit error in response to that the voltage value obtained via the AD is maintained at a value above a predetermined reference value.

For example, in response to that a state in which the AD value is lower than 5 has been maintained for 10 seconds, the MC board may determine that an open-circuit error has occurred and then may notify the Android (board) of the thermistor open-circuit error.

In addition, in response to that a state in which the AD value exceeds 250 has been maintained for 10 seconds, the MC board may determine that a short-circuit error has occurred and may notify the Android (board) of the thermistor short-circuit error.

The Android (board) that controls the digital controller door may provide a guide phrase related to such an error notification in a pop-up manner or in an alarm manner. The Android (board) may receive a response indicating that the user has confirmed the notification through a UI indicating that the user has confirmed the notification (for example, the user may touch the contents displayed in the pop-up manner such that the pop-up disappears). Such a pop-up may be provided as an on-going notification.

In an embodiment, the Android displays the guidance phrase related to the thermistor operation error on the screen in a pop-up manner and provides a touch button on the screen for the user to select the acknowledgement (OK). Upon checking the notification, the user may remove the pop-up.

In addition, the Android (board) may repeatedly display an alarm related to the thermistor operation error continuously until the error occurring in the thermistor has been removed. To this end, the MC board continuously detects the state of the thermistor even when an error occurs in the thermistor, and notifies the Android (board) that the thermistor is in the normal state when the error state has been removed. When the Android (board) has confirmed that the error has been removed, the Android allows the previous error notification message to be removed from the screen and allows the cooking appliance to be normally controlled.

When the guidance phrase due to the thermistor error is displayed as a pop-up, the Android or microcomputer may operate the ventilation fan 590 at a middle operation level and operate the DC fan as an embodiment of the door fan 180 at a high operation level. All of functions of the product may normally operate. For example, each of the functions of the product such as an auto-ventilation function may operate normally. In addition, in this process, the microwave oven may continue to perform the function without being stopped.

When the error of the thermistor has been removed, the on-going notification may be removed and the ventilation fan 590 may be turned off. However, the DC fan may operate under a temperature algorithm.

Since the digital controller door has the display and thus becomes sensitive to humidity, it is important whether the thermistor operates normally. Therefore, the cooking appliance including the digital controller door checks the state of the thermistor so that the cooking appliance may be safely controlled.

In addition, the digital controller door may provide a user interface for displaying items related to the termination of the cooking appliance when the thermistor error occurs so that the user may apply for an A/S for the cooking appliance.

An embodiment of the present disclosure in which all the components are combined with each other or operate in combination with each other has been described. However, the present disclosure is not necessarily limited to this embodiment. Within the scope of the purpose of the present disclosure, at least two of all components may be selectively combined with other or may operate in the selectively combined manner with other. Furthermore, each of the components may be implemented as an independent hardware. However, some or all of the components may be selectively combined with each other and thus may be implemented using a computer program with a program module to perform some or all of the functions combined in one or more pieces of hardware. The codes and code segments that constitute the computer program may be easily deduced by a person skilled in the art from the present disclosure. The computer program may be stored in computer readable media and read and executed by a computer, thereby implementing the method of the present disclosure. The storage media for storing the computer program may include storage media including magnetic recording media, optical recording media, and semiconductor recording devices. Additionally, the computer program implementing an embodiment of the present disclosure includes a program module transmitted in real time through an external device.

Although the embodiments of the present disclosure have been described in more detail with reference to the accompanying drawings, the present disclosure is not necessarily limited to these embodiments, and may be modified in a various manner within the scope of the technical spirit of the present disclosure. Accordingly, the embodiments as disclosed in the present disclosure are intended to describe rather than limit the technical idea of the present disclosure, and the scope of the technical idea of the present disclosure is not limited by these embodiments. Therefore, it should be understood that the embodiments described above are not restrictive but illustrative in all respects. In addition, even though an effect of a configuration of the present disclosure is not explicitly described in describing the embodiment of the present disclosure above, it is obvious that the predictable effect from the configuration should be recognized.

-Explanation of reference numerals-

| | |
|---|---|
| 100: digital controller door | 200: OS controller |
| 500: function unit | 550: function controller |
| 1000: cooking appliance | |

What is claimed is:

1. A cooking appliance including a digital controller door, the cooking appliance comprising:
a functional unit configured to provide a cooking function, wherein the functional unit includes a function controller for controlling an operation of the functional unit; and
the digital controller door configured to provide a human interface, wherein digital controller door includes an operating system (OS) controller for controlling the digital controller door,
wherein the function controller is configured to determine whether a thermistor error occurs,
wherein when the OS controller receives thermistor error notification from the function controller, the OS controller is configured to start a thermistor error response process.

2. The cooking appliance including the digital controller door of claim 1, wherein the function controller is configured to notify to OS controller of the thermistor error and receive an instruction to control a component of the functional unit from the OS controller.

3. The cooking appliance including the digital controller door of claim 1, wherein the function controller is configured to notify to OS controller of the thermistor error and control an operation of a component of the functional unit.

4. The cooking appliance including the digital controller door of claim 1, wherein in response to that the error of the thermistor has been removed and thus the thermistor operates normally, the function controller is configured to notify the OS controller that the thermistor operates normally.

5. The cooking appliance including the digital controller door of claim 1, wherein in response to that the output value of the thermistor is lower than a lowest reference voltage for a lowest reference time duration or the output value of the thermistor is higher than a highest reference voltage for a highest reference time duration, the function controller is configured to determine that the thermistor error occurs.

6. The cooking appliance including the digital controller door of claim 5, wherein the function controller is configured to notify the OS controller of a time duration for which the output value of the thermistor is lower than the lowest reference voltage has been maintained or a time duration for which the output value of the thermistor is higher than the highest reference voltage has been maintained.

7. The cooking appliance including the digital controller door of claim 6, wherein the OS controller is configured to:
store the notified time duration in a cumulative manner; and
in response to that a value of the cumulative time duration exceeds an allowable error time duration, output a guide phrase to a display of the digital controller door.

8. The cooking appliance including the digital controller door of claim 1, wherein the OS controller is configured to:
output a guide phrase corresponding to the notification of the thermistor error to a display of the digital controller door; and
control an operation of each of a ventilation fan and a door fan of the functional unit.

9. The cooking appliance including the digital controller door of claim 8, wherein the OS controller is configured to store state information of each of components of the functional unit and state information of each of components of the digital controller door,
wherein the OS controller is configured to control the operation of each of the ventilation fan and the door fan of the functional unit, based on the stored state information.

10. The cooking appliance including the digital controller door of claim 9, wherein upon receiving the thermistor error notification, the OS controller is configured to increase an operation level of each of the ventilation fan or the door fan set before the thermistor error notification.

11. A method for monitoring a thermistor by a digital controller door of a cooking appliance, wherein the cooking appliance includes:
a functional unit configured to provide a cooking function, wherein the functional unit includes a function controller for controlling an operation of the functional unit; and
the digital controller door configured to provide a human interface, wherein digital controller door includes an operating system (OS) controller for controlling the digital controller door,
wherein the method comprises:
determining, by the function controller, whether a thermistor error occurs;
receiving, by the OS controller, thermistor error notification from the function controller; and
starting, by the OS controller, a thermistor error response process.

12. The method for monitoring the thermistor of claim 11, further comprising: notifying, by the function controller to OS controller of the thermistor error, and
receiving, by the function controller, an instruction to control a component of the functional unit from the OS controller.

13. The method for monitoring the thermistor of claim 11, further comprising: notifying, by the function controller to OS controller of the thermistor error, and
controlling, by the function controller, an operation of a component of the functional unit.

14. The method for monitoring the thermistor of claim 1, further comprising:
in response to that the error of the thermistor has been removed and thus the thermistor operates normally, notifying, by the function controller, the OS controller that the thermistor operates normally.

15. The method for monitoring the thermistor of claim 11, further comprising:
in response to that the output value of the thermistor is lower than a lowest reference voltage for a lowest reference time duration or the output value of the thermistor is higher than a highest reference voltage for a highest reference time duration, determining, by the function controller, that the thermistor error occurs.

16. The method for monitoring the thermistor of claim 15, further comprising notifying, by the function controller, the OS controller of a time duration for which the output value of the thermistor is lower than the lowest reference voltage has been maintained or a time duration for which the output value of the thermistor is higher than the highest reference voltage has been maintained.

17. The method for monitoring the thermistor of claim 16, further comprising:
storing, by the OS controller, the notified time duration in a cumulative manner; and
in response to that a value of the cumulative time duration exceeds an allowable error time duration, outputting, by the OS controller, a guide phrase to a display of the digital controller door.

18. The method for monitoring the thermistor of claim 11, further comprising:
outputting, by the OS controller, a guide phrase corresponding to the notification of the thermistor error to a display of the digital controller door; and
controlling, by the OS controller, an operation of each of a ventilation fan and a door fan of the functional unit.

19. The method for monitoring the thermistor of claim 18, further comprising:
storing, by the OS controller, state information of each of components of the functional unit and state information of each of components of the digital controller door, and
controlling, by the OS controller, the operation of each of the ventilation fan and the door fan of the functional unit, based on the stored state information.

20. The method for monitoring the thermistor of claim 19, further comprising:
upon receiving the thermistor error notification, increasing, by the OS controller, an operation level of each of the ventilation fan or the door fan set before the thermistor error notification.
